(19) United States
(12) Patent Application Publication
(10) Pub. No.: US 2007/0011703 A1
(43) Pub. Date: Jan. 11, 2007

(54) Content selection and retrieval system

(76) Inventor: Richard L. Anglin JR., Del Mar, CA (US)

Correspondence Address: Giaccherini, Post Office Box 1146, Carmel Valley, CA, 93924, US

(21) Appl. No.: 11/176,006

(22) Filed: Jul. 5, 2005

(51) Int. Cl. H04N 7/10; G06F 3/00; G06F 13/00; H04N 7/025; H04N 5/445

(52) U.S. Cl. 725/46; 725/34; 725/35

(57) ABSTRACT

The present invention comprises methods and apparatus for providing more content choices to consumers (14) independent of their geography. In one embodiment of the invention, a consumer (14) uses a content terminal (18) to enjoy and audio and/or video content based on a customized set of content preferences (36). The present invention retrieves this preferred content utilizing a wired or wireless Internet connection (20), irrespective of the location of the user (14). In one embodiment of the invention, the content terminal (18) is a personal computer, cell phone, portable television or some other appropriate content replication appliance.

### FEDERALLY SPONSORED RESEARCH OR DEVELOPMENT

None.

### FIELD OF THE INVENTION

The present invention pertains to methods and apparatus for providing access to desired content in a any location which offers wired or wireless access to the Internet. More particularly, one preferred embodiment of the invention allows a user to view preferred content using a content terminal and a SIM card.

### BACKGROUND OF THE INVENTION

The vast majority of real-time broadcasts of audio-visual content, such as cable, over-the-air or satellite television and radio, are constrained by geography. A particular over-the-air radio or television broadcast is only available to a conventional radio or television receiver if the user is within the broadcast footprint of the transmitting station. Cable subscribers must be linked to a wired or wireless cable connection, and may only receive content conveyed by the cable operator or network. Even direct-to-home satellite radio and television broadcasts are limited by the continental footprints of the satellite signal.

As a result, a person in one location may be unable to enjoy content that is broadcast in another place that is remote from his own present location.

The development of a system would enable users to enjoy audio and/or video content in any location would constitute a major technological advance, and would satisfy long felt needs and aspirations in the telecommunications and electronics industries.

### SUMMARY OF THE INVENTION

The present invention comprises methods and apparatus for providing more content choices to consumers independent of their geography. In one embodiment of the invention, a consumer uses a content terminal to enjoy and audio and/or video content based on a customized set of content preferences. The present invention retrieves this preferred content utilizing a wired or wireless Internet connection, irrespective of the location of the user. In one embodiment of the invention, the content terminal is a personal computer, cell phone, portable television or some other appropriate content replication appliance.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 shows a generalized map of the United States. Eight different transmitters located in eight different geographic regions broadcast eight generally different programs of content.

FIG. 2 shows a motorist who is unable to enjoy content broadcast by a distant transmitter.

FIG. 3 shows a traveler who is enjoying content that originates from a radio station near his home in accordance with the present invention.

FIG. 4 is a schematic block diagram which illustrates the routing of a preferred selection of content over the Internet to a user in a distant location.

FIG. 5 is another schematic block diagram which reveals the generalized circuitry of a user's content terminal.

FIG. 6 presents a view of content preferences displayed on the screen of a user's content terminal.

FIG. 7 shows a Subscriber Identity Module (SIM), also known as a “smart card.”

FIG. 8 shows an example of the digital information that may comprise the digital information embodied in the SIM.

FIG. 9 shows a cable television or digital broadcast satellite set top box with a plurality of slots for Subscriber Identify Modules.

FIG. 10 shows a set top box distribution of programming using wires.

FIG. 11 shows a set top box distribution of programming using wireless communications devices.

FIG. 12 shows multiple facilities in different locations with access to the same cable television system.

FIG. 13 shows a Subscriber Identity Module (SIM) with an embedded biometric identification device.

FIG. 14 shows multiple facilities in different locations with access to the same digital broadcast satellite system.

FIG. 15 shows getting a user's desired programming from his or her home system to a foreign system in which he or she is located.

FIG. 16 shows the correlation table that allows a foreign system to deliver desired programming to a user from another system.

FIG. 17 shows an intermediary based business model for the distribution of programming.

FIG. 18 shows the programming feed connected to a fixed wireless communications system.

FIG. 19 shows the programming feed connected to a fixed wireless communications system with wireless distribution.

FIG. 20 shows a system for delivering content wirelessly directly to users whether fixed or mobile.

FIG. 21 shows content terminals embedded into fixed and mobile conveyances.

### A DETAILED DESCRIPTION OF PREFERRED & ALTERNATIVE EMBODIMENTS

I. Overview of the Invention & Definitions

The present invention comprises methods and apparatus for furnishing a menu or library of content to a user via an Internet connection. In one embodiment, the invention comprises a content terminal that retrieves selected audio and/or visual content from the Internet based on a user's personal preferences.

In this Specification and in the Claims that follow, the term “broadcast” refers to a method of signal conveyance that propagates from a transmitter to a number of terminals in remote locations. The term “signal” may be used to encompass many forms of content, including, but not limited to, video, still images, audio, text or any other form of intelligence, data or communication

The present invention may be implemented using a personal or portable computer, television, cellular phone, or information appliance, or any other means for exhibiting or reproducing data.

II. A Detailed Description of the Invention

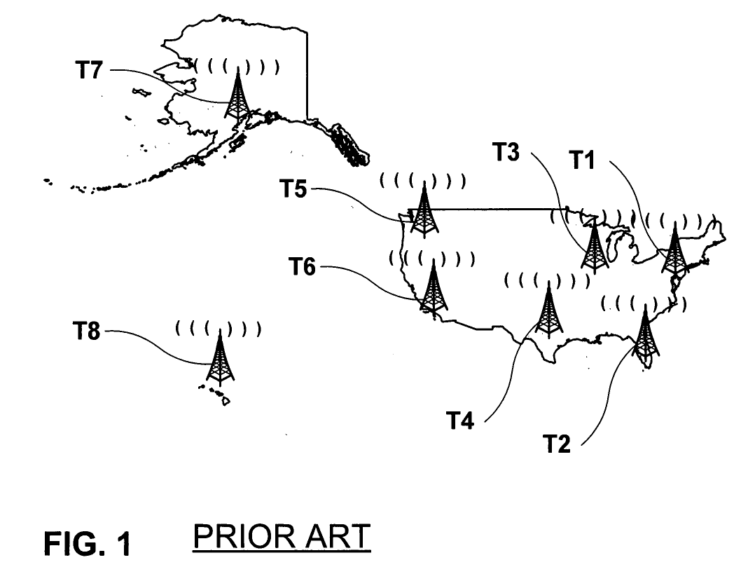

FIG. 1 shows a map of the United States. Eight transmitters, T1, T2, T3, T4, T5, T6, T7 and T8 broadcast conventional radio or television signals from New York, Miami, Chicago, Dallas, Seattle, Los Angeles, Anchorage and Honolulu respectively. Each of these eight conventional over-the-air signals may generally be received and enjoyed by users in a geographic region near or around each transmitter. For example, persons with conventional AM radios in Los Angeles are generally not able to receive radio broadcasts from AM stations that emit signals in New York.

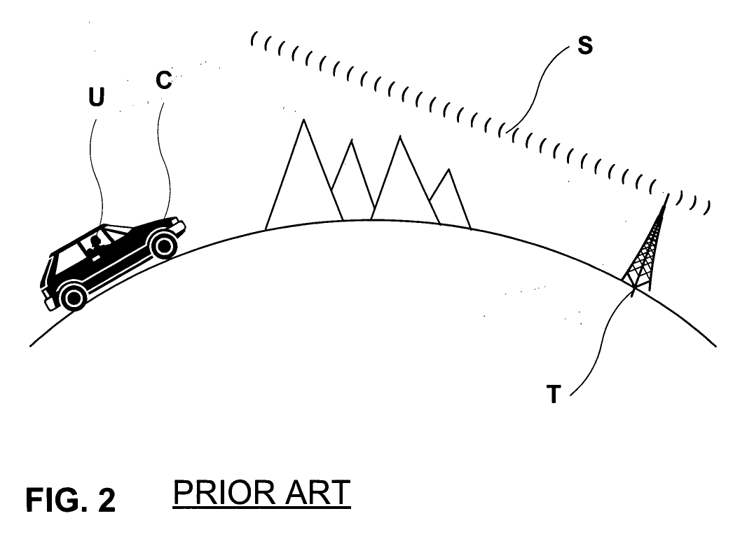

FIG. 2 depicts the same problem in a different setting. A motorist M traveling in his car C is too far away from a conventional over-the-air transmitter T to receive the distant radio signal S using his conventional car radio.

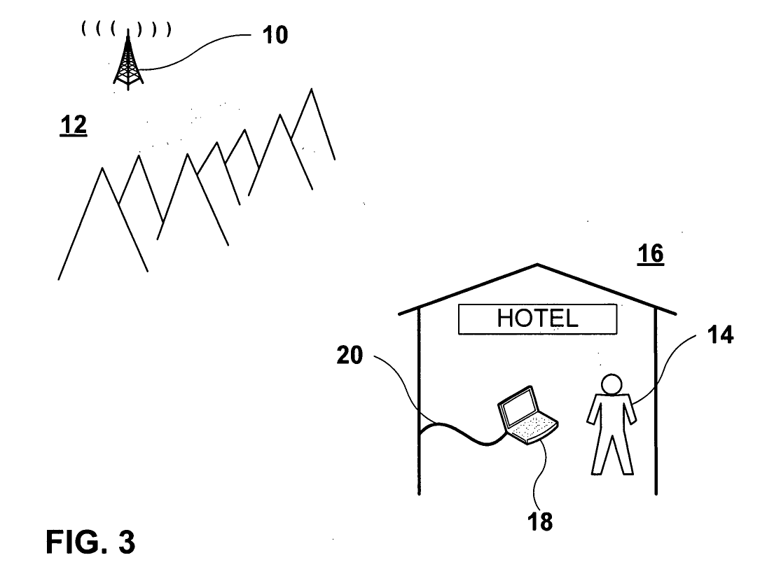

FIG. 3 offers a simplified illustration of one embodiment of the present invention. A conventional transmitter 10 located in a particular city 12 broadcasts a conventional over-the-air radio broadcast. When a person 14 who lives in that city 12 travels away from home to a distant location 16, he is unable to enjoy the radio program broadcast by his hometown transmitter 10. In accordance with the present invention, the traveler 14 is able to enjoy his favorite hometown radio program using a content terminal 18 and a connection to a network 20.

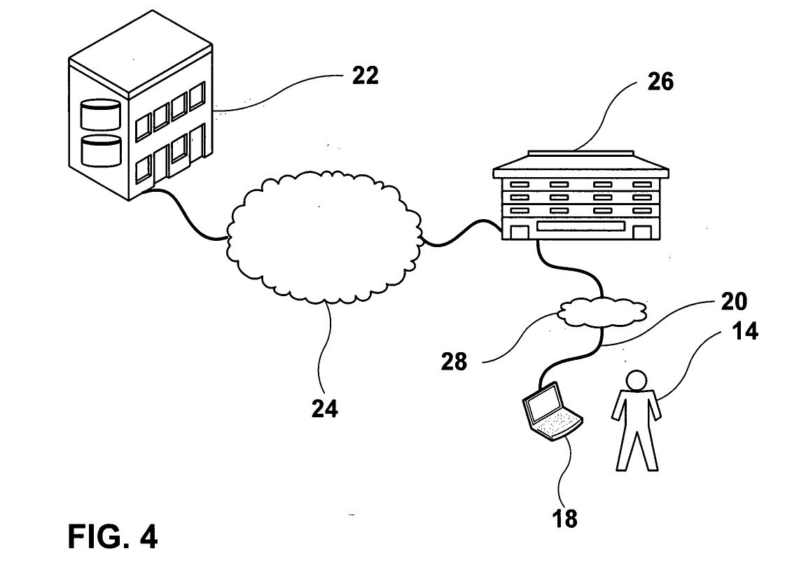

FIG. 4 provides a more schematic view of the generalized embodiment of the invention shown in FIG. 3. A content broadcaster 22 makes the content broadcast by his station available to users 14 who are connected to the Internet 24. Users 14 are linked to the Internet 24 via an Internet Service Provider 26, which allows them to use a content terminal 18 to retrieve audio and/or visual content or other forms of data or information. The content may be stored in a network cache 28. This network cache 28 may be located at the Internet Service Provider 26, in the content terminal 18, or at some other location that may be connected to the Internet 24 or some other network.

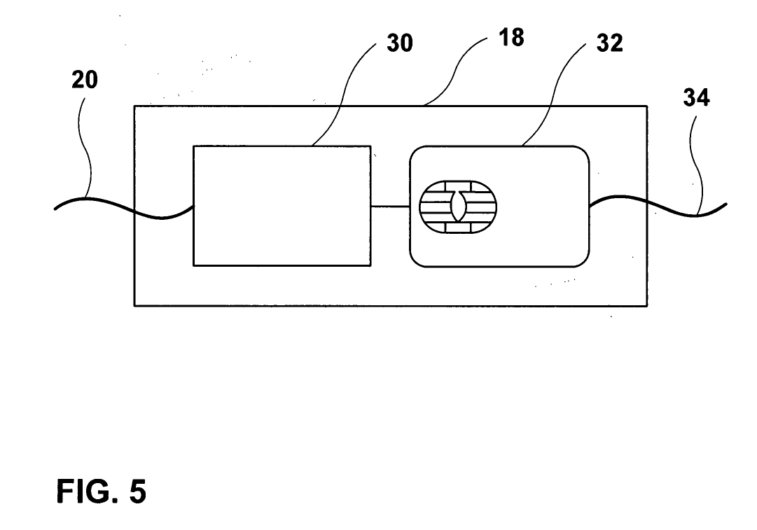

FIG. 5 supplies a more detailed schematic portrayal of this embodiment of the invention. The content terminal 18 includes a content retriever 30 and a Subscriber Identity Module “SIM” 32. The content retriever 30 is able to retrieve selected content using the connection 20 to the Internet 24 based on the preferences stored in the memory of the SIM 32. Today the most common manifestation of a “SIM” is a small electronic card that may be inserted into a mobile cellular phone. The SIM associates a fixed unique identification to that device. The SIM enables a cellular phone company to track phone calls from that phone to provide billing statements to a customer. The SIM may also be employed to gain access to different cellular networks, or to encrypt phone calls. SIMs are increasingly used in a variety of applications. For example, soldiers' medical records are stored in SIMs embedded into their military identification cards. Similarly, many companies are using SIM-based identification cards to control access to facilities, especially facilities comprising sensitive information or activities.

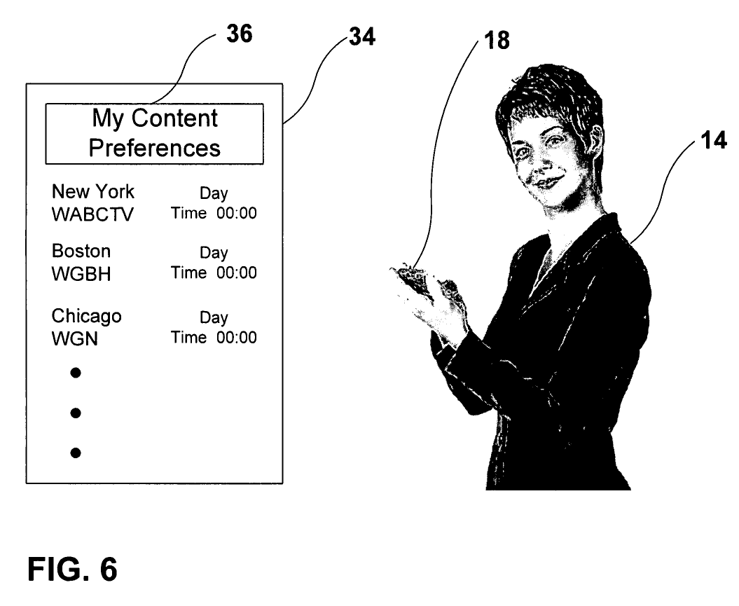

FIG. 6 reveals a user 14 programming her content terminal 18. By selecting a list of content or programs presented on the display 34 of the content terminal 18, the user 14 instructs the SIM 32 to automatically retrieve content from the Internet 24 and then store it in her content terminal 18 or the network cache 28 so that the user 14 may enjoy the content at the time of her choosing. The user 14 selected content comprises the user's 14 content preferences 36.

III. Details of Specific Implementations of the Invention

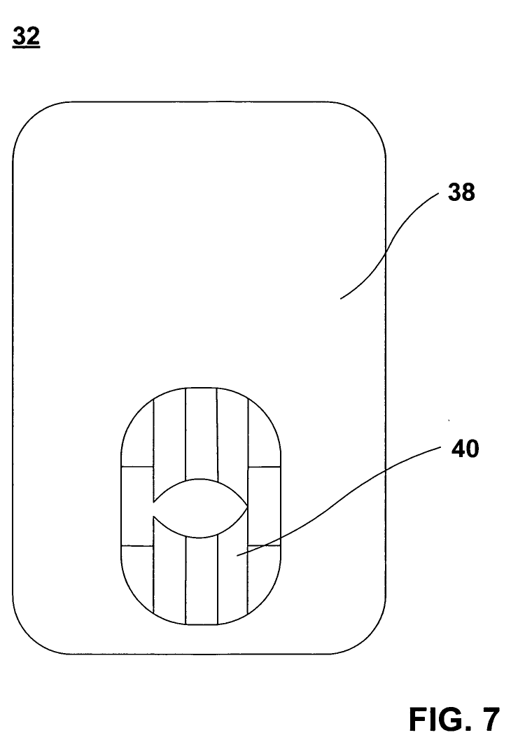

FIG. 7 offers a schematic depiction of the SIM 32, which may comprise a small card or substrate 38 that includes an embedded electronic memory and processor 40. In some instances, the SIM is also referred to as a “smart card.” In one embodiment of the invention, the SIM 32 is used to store content preferences 36 specified by the user 14. The SIM memory 40 may also retain information that is employed for user authentication, authorization and validation. Any device and/or software and/or user input may provide an equivalent means of performing the function of the SIM. For example, the user may enter a password or some other form of identification, instructions or preferences instead of relying upon information stored in the SIM 32.

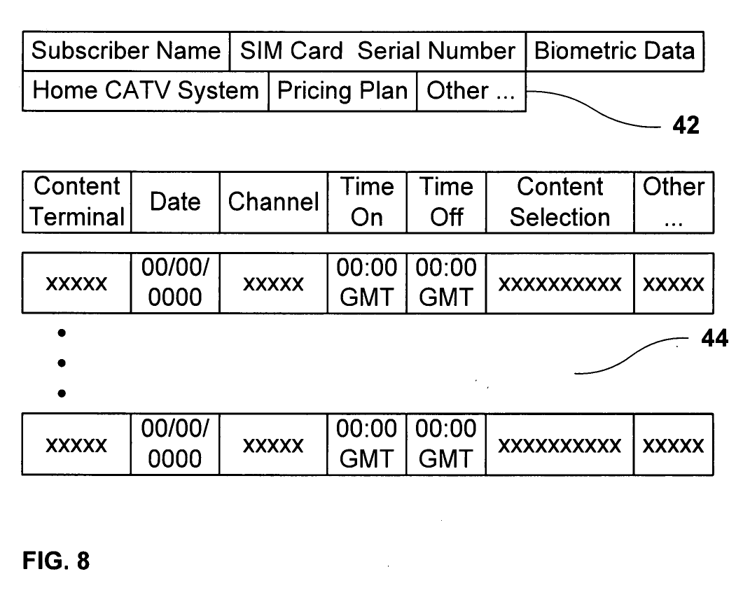

FIG. 8 presents a depiction of classes of information that may be stored in the SIM 32. Among the various kinds of information that may be stored in the SIM 32 may include, but is not limited to, basic operating information 42, such as a user or subscriber name, a SIM card serial number, biometric data, identifying information concerning the user's home Community Access Television (CATV) system, better known as his or her “cable television system,” and pricing plan. The SIM 32 may also be utilized to store a schedule 44 which contains a specification of a content terminal 18 and information pertaining to a content selection 36, including, but not limited to, the title, the date and time of its emanation from a content source, and the date and time for delivery to a content terminal.

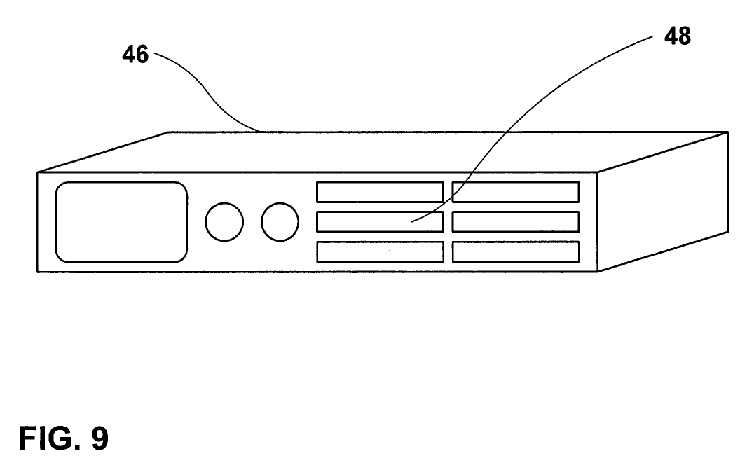

In an alternative embodiment of the invention, a set top box 46 that is capable of receiving signals from a CATV or Direct Broadcast Satellite (DBS) is configured with one or more slots 48 to receive one or more SIMs 30 as shown in FIG. 9. A set top box 46 with multiple slots 48 allows more than one user 14 to record and store their content preferences 38.

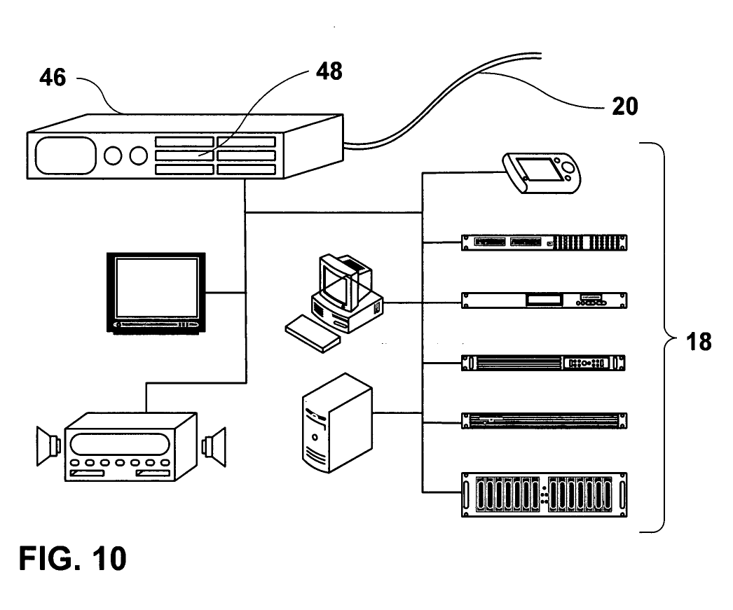

The set top box 46 may utilize an Internet connection 20 to route content selections 36 to a wide variety of content terminals 18, including, but not limited to, including a radio, a personal computer (PC), a programming content server, a video cassette recorder or players (VCR), a digital video disk player or recorder (DVD), a compact disk player or recorder (CD), a personal digital recorder such as a TiVo®, a CD/DVD juke box and a game device, such as the Sony PlayStation® or the Sony PSP®. FIG. 10 illustrates some of these content terminals 18, which may be used to “time shift” a user's content selection 36 because the user 14 may choose the time to use or to enjoy the content selection 36 stored in his or her content terminal 18 or the network cache 28.

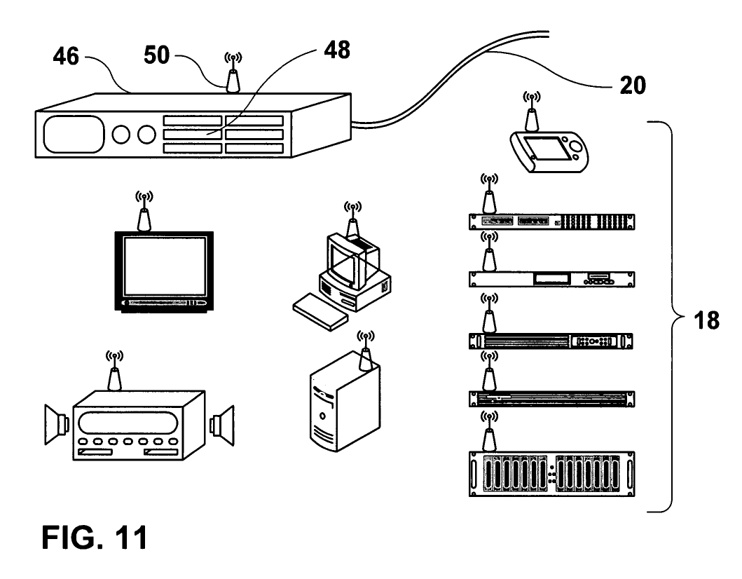

FIG. 11 shows a CATV or DBS set top box 46 distributing programming wirelessly. The set top box 46 and each of the content terminals 18 include a wireless communications device 50, which may utilize a wide variety of wireless formats, including, but not limited to, WiFi, WiMax® or Bluetooth®.

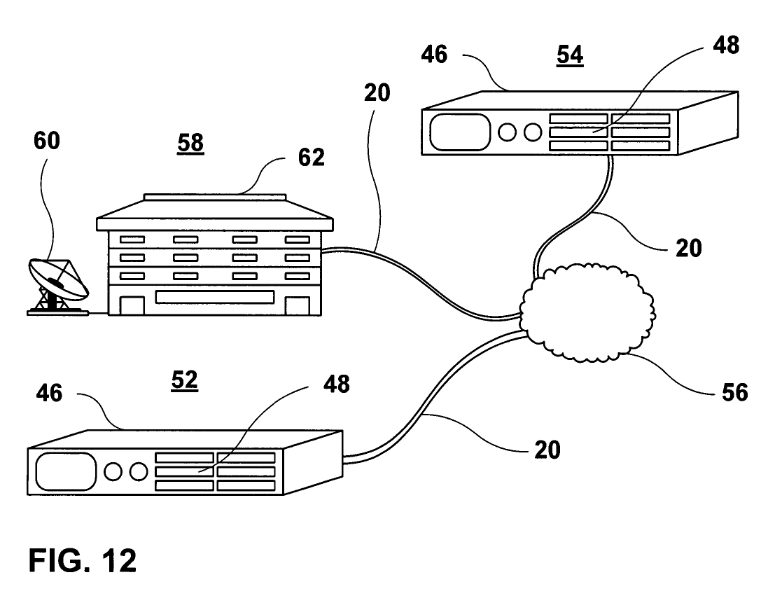

If a user 14 has multiple facilities within the same CATV system, he or she may obtain access to their preferred content selections 36 from virtually any location, as long as they transport a SIM 32 from place to place, as shown in FIG. 12. The user 14 may remove his or her SIM 32 from the set top box 46 in a first location 52 and transport it to a second location 54. Because both set top boxes 46 are connected to the same network 56, the same content selections 36 may be accessed from the content source 22 via the CATV head end 58. The CATV head end 58 comprises one or more satellite Earth stations 60 for receiving content selections 36 from distant locations as well as other facilities for collecting, storing and/or distributing such content selections 62, including the programming cache 28. Obtaining content selections 36 using a DBS system would employ a similar method and apparatus.

In one embodiment of the invention, set top box 46 is assigned a unique equipment identification number, which would be registered with the CATV or DBS system. Additionally, each SIM 32 would also be associated with a unique identification number. All set top boxes 44 and SIMs 30 would be registered with the CATV or DBS system. The inherent tranportability of the SIM 32 makes additional means for customer authentication, authorization and validation highly desirable.

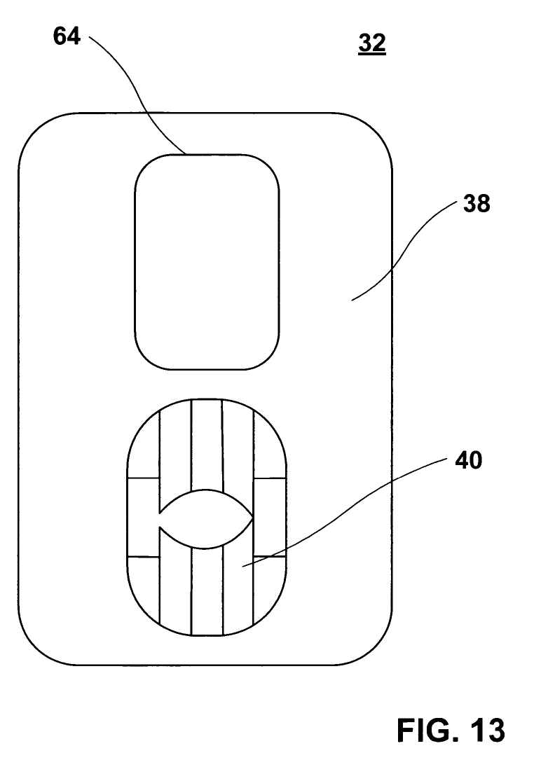

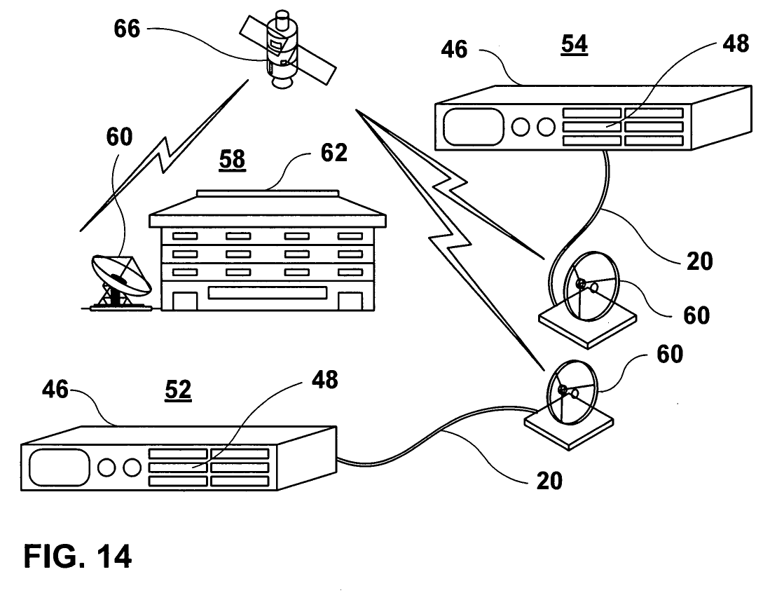

One alternative implementation that achieves this additional security uses a biometric identification device 64 embedded in the SIM 32, as shown in FIG. 13. The biometric identification would be registered with the CATV or DBS system. When the SIM 32 is removed from the first location 52, access to programming is terminated. When the SIM 32 is inserted into the set top box 46 in the second location 54, the user 14 would be required to access the biometric device 64 to access his or her content selections 36. The biometric information would be sent to the CATV head end or to the DBS master uplink facility 58, and compared with the registered biometric information. When access is authorized, content selections 36 are sent from the an Earth station 60 at the DBS master uplink facility 58 to a satellite 66, then back down to another Earth station 60 and then on to a content terminal 18 over a network connection 20, as shown in FIG. 14.

The term “biometric authentication” refers to the automatic identification, or identity verification, of living individuals using physiological and behavioral characteristics. Today common biometric devices 64 are fingerprint readers. The user 14 touches his or her finger to the biometric device 64, which scans his or her fingerprint and matches it to a scan stored in a system's basic operating information 42. Single finger readers are available from Identix®, Inc., for example.

A user may be in a different CATV or DBS system from his or her residence and wish to have access to his content selections 36. To implement such cross-system access, an operations support system (OSS), including billing, is employed to authenticate, authorize and verify the user's connection to the system. One such OSS is that utilized by cellular and PCS systems. In these systems, a user's access, authentication, authorization and verification information is contained in his or her “home” system's Home Location Register (HLR). When the user tries to get cellular or PCS access in another system, the system being visited sends a request to the home system to verify that the user is authorized to use system assets. Upon verification, the user's information is written in the Visitor Location Register (VLR) in the foreign system. The VLR controls visitor access in the foreign system.

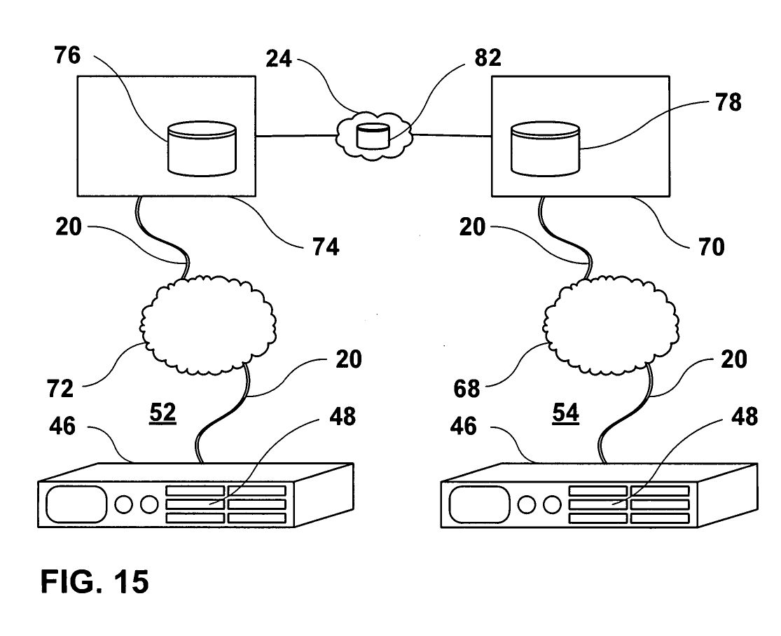

Foreign system access is described in FIG. 15. When the consumer inserts his or her SIM 32 into the set top box 46 in a foreign location 54, a message is sent through the foreign CATV system 68 to the foreign system head end 70. The foreign head end 70 sends a message via the Internet 24, to the home system 72 head end 74 to verify that the user 14 is authorized to access a content selection on his or her set top box 46. The user's information, which is stored in the home system's database 76, is sent from the home system to the foreign system's database 78, and the user 14 is granted access to his or her content selections 18. The home system's database 74 also stores the channel structure 80 of the content selections 18, that is, what programming is shown on which channel within the system. For example, on the TimeWarner® CATV system in San Diego, Calif., TNT® is shown on channel 27, TBS® on channel 2, WGN® on channel 3, Comedy Central® on channel 68, and so forth. This information is also sent to the foreign system's database 78 so that the foreign system 68 knows which programming to deliver to the user 14.

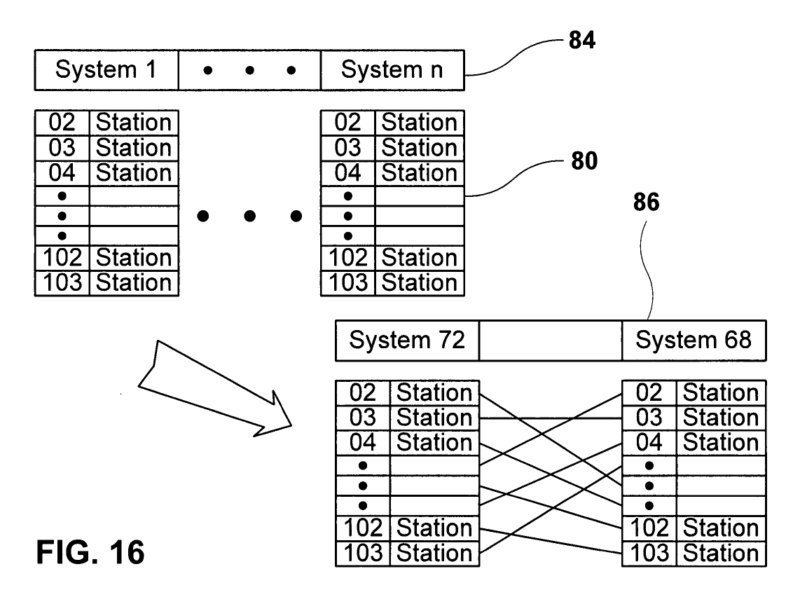

In another alternative embodiment of the invention, the channel structure information is stored in a centralized database 82 and available to all systems. Companies like TVGuide® have channel information for the CATV and DBS systems for which they provide an on-line channel guide. The centralized database 82 would comprise a CATV and DBS system identifier 84 and the channel structure 80 for that system as shown in FIG. 16. When the user 14 inserts his or her SIM 32 into a set top box 46 in a foreign location 54, a request is sent to the centralized database 82. The centralized database 82 would build a table of cross references 86 of content selections 18 showing how the channel structure 80 of the home system 72 relates to the channel structure 80 of the foreign system 68, and send it to the foreign system 68 database 78. This cross-reference table 86 enables the foreign system 68 to deliver the user's 14 desired programming to him or her in the foreign location 54.

In an alternative embodiment of the invention, content selections 18 are delivered to users 14 via the Internet 24. The cross-reference table 86 aligns the national distribution channels like HBO®, TBS®, TNT®, Discovery®, Animal Planet, ESPN® and the like. For delivery by the Internet, the cross reference table 86 is implemented in the foreign system 68 it can request that the home system 72 send the appropriate programming to it for distribution the user 14 in the foreign location 54. In other words, when the user 14 is in New York 54, the New York system 68 can request the user's 14 home system 72 in San Diego to send it 68 the San Diego NBC® affiliate KNSD to deliver to the user 14.

Assume for the remainder of the discussion that any CATV or DBS system uses the Internet-standard Transmission Control Protocol/Internet Protocol (TCP/IP) and is connected to the Internet.

In an Internet-based embodiment, the process of delivering desired programming 36 to a user is highly simplified technically but may be considerably complicated by laws and regulations. In the first instance, the desired programming 32 may simply be routed from the home system 72 via the Internet 24 to the foreign system 68 according to the user's 14 preferences stored in his or her SIM 32. Here the desired programming 36 would simply be routed to the user 14 in a foreign location 54 at the time is it delivered in the home system 72. If the user 14 is in New York 54 and wants to see his or her San Diego 52 programming, the three hour time change simply means the user 14 would see a 4 p.m. PST program in San Diego 52 at 7 p.m. EST in New York 54. Alternatively, if the user was in Japan 54, the 4 p.m. PST programming would show at 8 a.m. JST, which may or may not be convenient for the user 14. Alternatively, if the user was in Switzerland, the 4 p.m. PST programming would show at 1 a.m. EST, most likely inconvenient for the user 14.

It would be much more preferable for the user 14 to view his or her desired programming 32 at its usual time regardless of where the user 14 is located. To do this requires some type of time shifting device 18 or method. If the time shifting devices 18 in the user's 14 premises are connected to the Internet 24, the user's 14 programming preferences 36 can be captured by one or more of the time shifting devices 18 at the time they are normally delivered in the home system 72. Then at the user's 14 desired viewing time in the foreign location 54, the programming can be sent from the time shifting device 18 out through the home system 72 over the Internet 24 to the foreign location 54 via the foreign system 68. There are regulatory issues associated with this scenario.

An alternative would be for the user's 14 preferred programming 36 to be cached 28 within his or her home system 72 for delivery whenever the user's 14 SIM 32 appears with a foreign system 68. The home system 72 would know that the user's 14 SIM 32 is not registered with the home system 72 but would deliver the preferred programming 36 upon notification that the user's 14 SIM 32 registered in a foreign system 68.

A further alternative would be to store the user's 14 programming preferences 32 with a centralized database 82. His or her preferred programming 36 would be delivered to the home system 72 or a foreign system 68 according the preferences 36 stored within the centralized database 82.

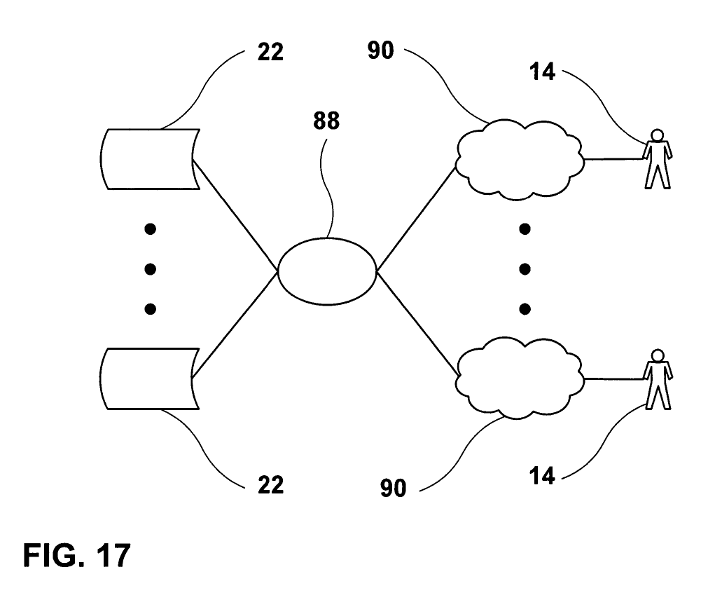

FIG. 17 depicts an Internet-based approach to the delivery of programming. Content providers 22, for example, ESPN®, TNT®, TBS®, HBO®, KNSD®, XM Satellite Radio®, the California Continuing Education of the Bar and the like, license their programming to an intermediary 88, a “broker,” for delivery via some system 90 to users 14. The systems 90 could be traditional CATV or DBS systems, or any other wired or wireless communications systems like ordinary telephone service, cellular, PCS, WiFi, Wi-Max®, or systems yet unknown

CATV systems are today monopolies within a specific geographic area, for which exclusivity the CATV system pays a franchise fee to the local government. To the extent that the system 90 that the intermediary 88 uses to deliver programming 36 to a user 14 is a CATV system, then the franchise fee would be embedded into the fees paid by the intermediary 88 to the system operator. Traditional wireless cable systems (not Internet-based) likewise pay local franchise fees. If, however, the content is delivered wirelessly direct to a user 14 using an Internet-based approach, then a local franchise fee would not apply because the Federal Communications Commission (FCC) has ruled that Internet access is a data service not subject to traditional communications regulations.

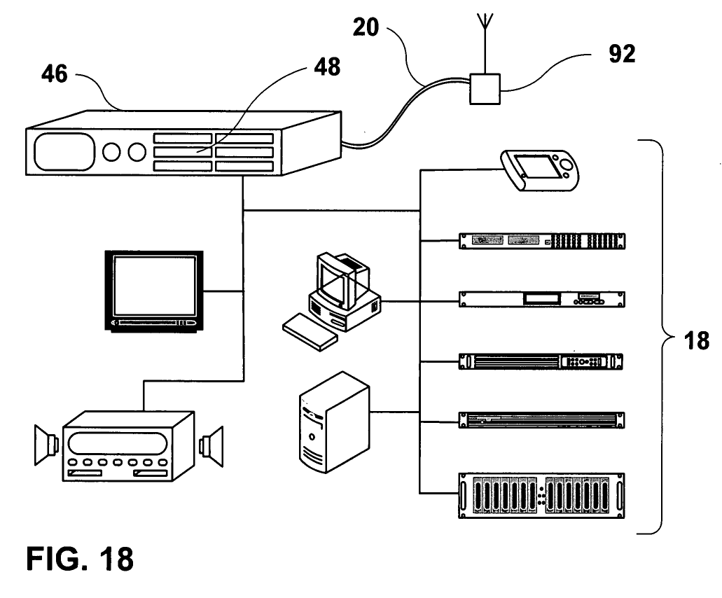

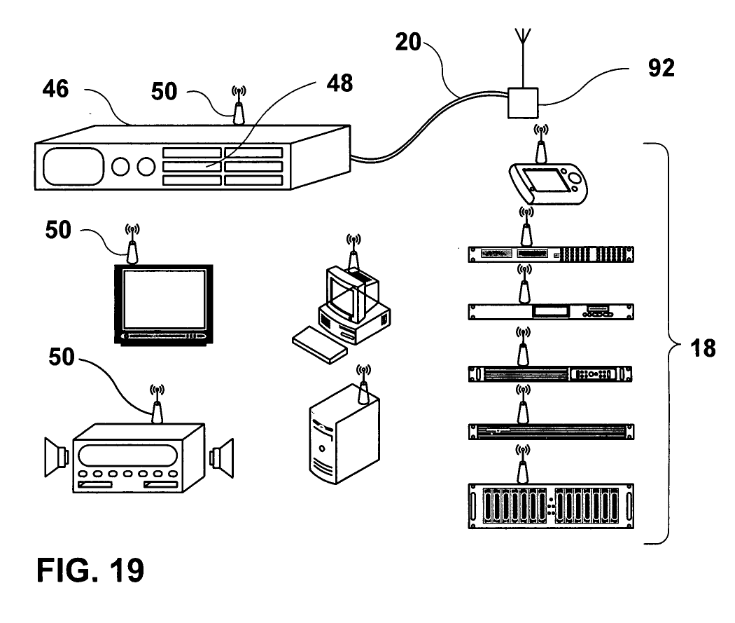

A preferred embodiment of the instant invention comprises wireless delivery of preferred programming 36 directly to a user 14 via the Internet. Thus, the system described in FIG. 10 becomes the system shown in FIG. 18, where the programming feed 20 connects to a fixed wireless communications system 92. Similarly, FIG. 11 becomes FIG. 19.

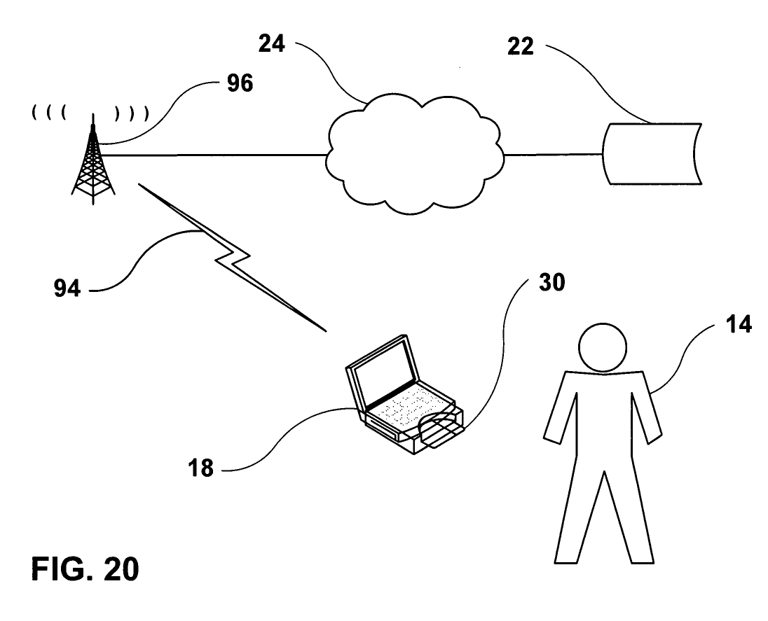

A preferred embodiment of the disclosed invention is to deliver the preferred programming 36 directly to a user 14, whether the user 14 is in a fixed location or mobile. Such a system is shown in FIG. 20. The user 14 inserts his SIM 32 into a content terminal 18 that sends an IP-based signal 94 to a base station 96 that accesses the global Internet 24 to retrieve content from providers 22. The preferred programming 36 is delivered via the Internet 24 to the base station 96 for delivery to the user's 14 content terminal 18 via an IP-based signal 94.

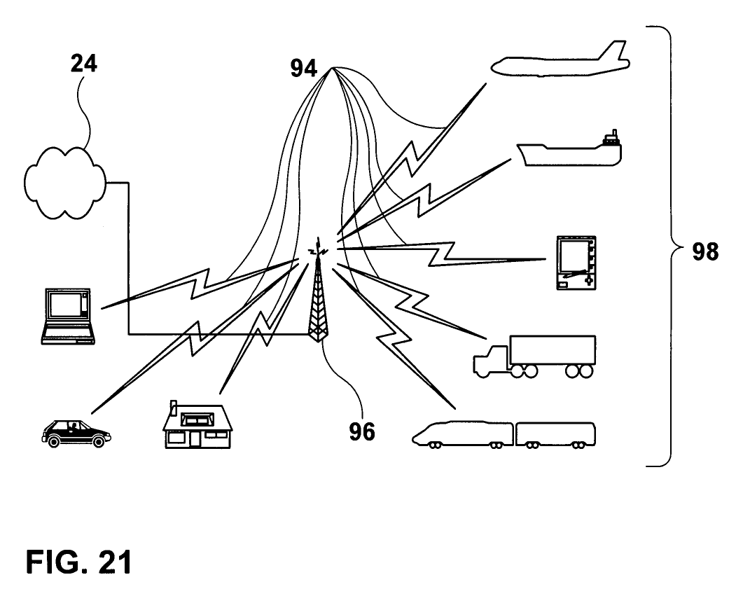

The envisioned content terminal 18, with its concomitant SIM 32, can be a stand alone device or built into mobile conveyances or fixed 98 as shown in FIG. 21. The inherent transportability of the SIM 30 combined with an Internet-based distribution system enables a user 14 to receive his or her preferred programming 36 anywhere in the world at a time and place of his or her choosing. Such a system would significantly advanced the state of the art and contribute innumerable economic benefits to users 14 and providers of such services.

### Conclusion

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

10 Hometown transmitter
12 Hometown
14 User
16 Distant location
18 Content terminal
20 Network connection
22 Content broadcaster
24 Internet
26 Internet Service Provider
28 Network cache
30 Content retriever
32 Subscriber Identity Module (SIM)
34 Content terminal display
36 User's content preferences
38 SIM substrate
40 SIM memory and processor
42 Basic operating information
44 Schedule of content slections
46 Set top box
48 Set top box SIM slot
50 Wireless transceiver
52 Local set top box
54 Remote set top box
56 Cable television network
58 Cable television network head end
60 Satellite Earth station
62 Facilities for collecting, storing and/or distributing programming
64 Biometric device
66 Satellite
68 Foreign cable television system
70 Foreign cable television system head end
72 Home cable television system
74 Home cable television system head end
76 Home cable television system database
78 Foreign cable television system database
80 Cable television or direct broadcast system channel structure
82 Centralized database
84 Cable television or direct broadcast system identifier
86 Cross reference table
88 Intermediary
90 System for the delivery of programming
92 Fixed wireless communications device
94 Wireless signal
96 Wireless base station
98 Devices, conveyances or fixed premises into which content terminals may be embedded

What is claimed is:

1. A method comprising the steps of:
specifying a plurality of content preferences for a user;
storing said plurality of content preferences in a network cache;
connecting said user to a network;
associating each one of said plurality of content preferences with one of a plurality of content sources;
each of said plurality of content sources being accessible by said user when connected to said network;
retrieving a plurality of content selections based on said plurality of content preferences by automatically downloading each of said content selections from one of said plurality of content sources;
storing said plurality of content selections in said network cache; and
reproducing a selected one of said plurality of content selections using a content terminal.

2. A method as recited in claim 1, in which said plurality of content preferences includes a radio program.

3. A method as recited in claim 1, in which said plurality of content preferences includes a television program.

4. A method as recited in claim 1, in which said plurality of content preferences includes an audio recording.

5. A method as recited in claim 1, in which said plurality of content preferences includes a video recording.

6. A method as recited in claim 1, in which said user is traveling away from home.

7. A method as recited in claim 1, in which said network cache is a server; said server being connected to said network.

8. A method as recited in claim 1, in which said network cache further comprises a plurality of storage devices in a peer-to-peer network.

9. A method as recited in claim 1, in which said network cache is located in said content terminal.

10. A method as recited in claim 9, in which said network cache which is located in said content terminal is a hard drive.

11. A method as recited in claim 9, in which said network cache which is located in said content terminal is a non-volatile, sold-state memory.

12. A method as recited in claim 1, in which said network is the Internet.

13. A method as recited in claim 1, in which said network is a private network.

14. A method as recited in claim 1, in which said plurality of content preferences is stored in a subscriber identity module in said content terminal.

15. A method as recited in claim 1, in which said plurality of content sources includes a website.

16. A method as recited in claim 1, in which said website provides access to one of said plurality of content selections.

17. A method as recited in claim 1, in which said automatic downloading occurs at a time selected by said user.

18. A method as recited in claim 17, in which said automatic downloading conveys one of said plurality of content selections from one of said plurality of content sources to said network cache.

19. A method as recited in claim 17, in which said automatic downloading conveys one of said plurality of content selections from one of said plurality of content sources to said content terminal.

20. A method as recited in claim 17, in which said automatic downloading conveys one of said plurality of content selections from said network cache to said content terminal.

21. A method as recited in claim 1, in which said content terminal is a mobile telephone.

22. A method as recited in claim 1, in which said content terminal is a portable computer.

23. A method as recited in claim 1, in which said content terminal is a personal digital assistant.

24. A method as recited in claim 1, in which said content terminal is installed aboard an aircraft.

25. A method as recited in claim 1, in which said content terminal is installed aboard an automobile.

26. A method as recited in claim 1, in which said content terminal is installed in a hotel.

27. A method as recited in claim 1, in which said content terminal is installed in a residence.
